(19) United States
(12) Patent Application Publication
(10) Pub. No.: US 2018/0121713 A1
(43) Pub. Date: May 3, 2018

(54) SYSTEMS AND METHODS FOR VERIFYING A FACE

(71) Applicant: QUALCOMM Incorporated, San Diego, CA (US)

(72) Inventors: Feng Guo, San Diego, CA (US); Yingyong Qi, San Diego, CA (US); Chienchung Chang, Rancho Santa Fe, CA (US)

(21) Appl. No.: 15/337,935

(22) Filed: Oct. 28, 2016

(51) Int. Cl. G06K 9/00; G06K 9/62; H04N 13/02; G06T 7/00

(52) U.S. Cl. CPC G06K 9/00288; G06K 9/00255; G06T 7/0024; H04N 13/0203; G06K 9/6202

(57) ABSTRACT

A method for verifying a face by an electronic device is described. The method includes obtaining a partial face depth map from a depth sensor. The partial face depth map does not include information for an entire face. The method also includes performing a first alignment of the partial face depth map with full face data in a gallery. The method further includes performing a second alignment of the partial face depth map and the full face data based on the first alignment. The method additionally includes verifying whether the partial face depth map matches the full face data based on the second alignment.

### FIELD OF DISCLOSURE

The present disclosure relates generally to electronic devices. More specifically, the present disclosure relates to systems and methods for verifying a face.

### BACKGROUND

In the last several decades, the use of electronic devices has become common. In particular, advances in technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Depth is a component of three dimensional (3D) space. For example, depth may be represented as a distance between two points in 3D space. Many difficulties arise in attempting to measure and utilize depth with electronic devices in real world situations.

In particular, the viewpoint from which depth is measured may provide only limited data in some cases. As can be observed from this discussion, improving depth data utilization may be beneficial.

### SUMMARY

A method for verifying a face by an electronic device is described. The method includes obtaining a partial face depth map from a depth sensor. The partial face depth map does not include information for an entire face. The method also includes performing a first alignment of the partial face depth map with full face data in a gallery. The method further includes performing a second alignment of the partial face depth map and the full face data based on the first alignment. The method additionally includes verifying whether the partial face depth map matches the full face data based on the second alignment.

Performing the first alignment may include determining a rigid transformation between the partial face depth map and the full face data. Performing the first alignment may include prioritizing one or more regions for alignment based on the mixture weights and transformations. Performing the second alignment may include performing point cloud matching between the partial face depth map and the full face data.

The method may include performing learning to determine a set of mixture weights and transformations. The mixture weights and transformations may indicate an expected frequency and location of the partial face depth map relative to the full face data.

The partial face depth map may include depth information corresponding to less than a nose, a mouth, and both eyes of the face. The face may not be occluded in a field of view of the depth sensor.

An electronic device for verifying a face is also described. The electronic device includes a depth sensor configured to obtain a partial face depth map. The partial face depth map does not include information for an entire face. The electronic device also includes a processor coupled to the depth sensor. The processor is configured to perform a first alignment of the partial face depth map with full face data in a gallery, to perform a second alignment of the partial face depth map and the full face data based on the first alignment, and to verify whether the partial face depth map matches the full face data based on the second alignment.

A computer-program product for verifying a face is also described. The computer-program product includes a non-transitory tangible computer-readable medium with instructions. The instructions include code for causing an electronic device to obtain a partial face depth map from a depth sensor. The partial face depth map does not include information for an entire face. The instructions also include code for causing the electronic device to perform a first alignment of the partial face depth map with full face data in a gallery. The instructions further include code for causing the electronic device to perform a second alignment of the partial face depth map and the full face data based on the first alignment. The instructions additionally include code for causing the electronic device to verify whether the partial face depth map matches the full face data based on the second alignment.

### BRIEF DESCRIPTION OF THE DRAWINGS

FIG. 1 is a block diagram illustrating one example of an electronic device in which systems and methods for verifying a face may be implemented;

FIG. 2 is a flow diagram illustrating one configuration of a method for verifying a face;

FIG. 3 is a diagram illustrating one example of a visualization of a partial face depth map;

FIG. 4 is a diagram illustrating an example of aligning a partial face depth map with full face data;

FIG. 5 is a diagram illustrating one example of a first alignment and a second alignment;

FIG. 6 is a block diagram illustrating a more specific example of an electronic device in which systems and methods for verifying a face may be implemented;

FIG. 7 is a block diagram illustrating an example of several components that may be implemented for verifying a face in some configurations of the systems and methods disclosed herein;

FIG. 8 is a flow diagram illustrating one configuration of a method for learning mixture weights and transformations; and

FIG. 9 illustrates certain components that may be included within an electronic device configured to implement various configurations of the systems and methods disclosed herein.

### DETAILED DESCRIPTION

The systems and methods disclosed herein relate to verifying a face. Verifying a face may include determining whether a face indicated by data (e.g., probe data, depth data, a partial face, etc.) matches a known face (e.g., a gallery face).

It may be beneficial to perform face verification based on partial face data (e.g., depth data). Face verification with partial face data may be performed when a depth map is available. Some approaches may deal with face recognition of a partially occluded face. However, these approaches may not enable partial face verification where only a partial face depth map is available. It should be noted that three-dimensional (3D) depth may be a useful source of information for face verification. Due to large amounts of data and/or increased complexity, it may be difficult to perform 3D face verification quickly and/or efficiently. Some configurations of the systems and methods disclosed herein may provide the benefit of performing 3D face verification quickly and/or efficiently.

Alignment of a partial face depth map to existing gallery data (e.g., one or more depth images) may be performed as part of partial face verification. Alignment can be a costly process. Some configurations of the systems and methods disclosed herein may reduce the cost of alignment by performing a two-step coarse-to-fine (C2F) approach to achieve fast and accurate alignment. Accordingly, some configurations of the systems and methods disclosed herein may provide coarse-to-fine partial three-dimensional (3D) face verification.

Some approaches may include a first alignment (e.g., coarse alignment) and a second alignment (e.g., fine alignment) of a partial face depth map. The first alignment may include finding a rigid transformation that aligns depth maps between a partial face and a full face. In some configurations, the second alignment may be performed with one or more point cloud matching algorithms (e.g., iterative closest point (ICP)). In some approaches, learning (e.g., offline and/or online learning) may be used to adaptively learn the user face location and transformation prior, which may help to quickly locate one or more regions of interest to start the initial alignment. With learning (after some adaptation, for example), performance may differ (e.g., improve) over time. Accordingly, some configurations of the systems and methods disclosed herein may utilize learning (e.g., online learning) for partial face verification. Partial depth map alignment and matching may be obtained quickly and accurately when there are missing data, self-occlusions, or large expression variations.

The systems and methods disclosed herein may be implemented in a variety of devices. For example, the systems and methods disclosed herein may be implemented in a smartphone, a vehicle (e.g., car, truck, aircraft, etc.), connected home devices, appliances, electronic devices, televisions, wearables, drones, robotics, etc. Additionally or alternatively, the systems and methods disclosed herein may be implemented in a wide variety of contexts. For example, the systems and methods disclosed herein may be implemented in applications for entertainment, productivity, navigation, safety and security, health and fitness, etc.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

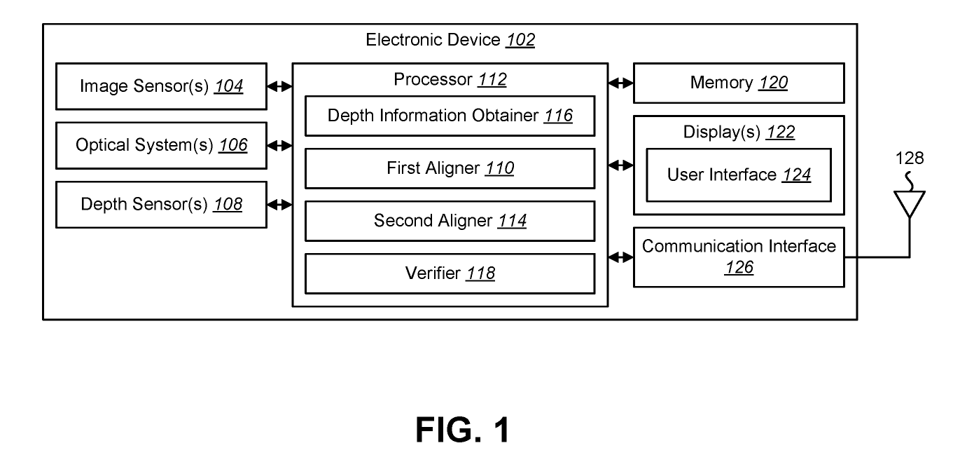

FIG. 1 is a block diagram illustrating one example of an electronic device 102 in which systems and methods for verifying a face may be implemented. Examples of the electronic device 102 include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, gaming consoles, personal digital assistants (PDAs), set-top boxes, security devices, etc. The electronic device 102 may include one or more components or elements. One or more of the components or elements may be implemented in hardware (e.g., circuitry) or a combination of hardware and software (e.g., a processor with instructions).

In some configurations, the electronic device 102 may include a processor 112, a memory 120, one or more displays 122, one or more image sensors 104, one or more optical systems 106, one or more depth sensors 108, and/or a communication interface 126. The processor 112 may be coupled to (e.g., in electronic communication with) the memory 120, display(s) 122, image sensor(s) 104, optical system(s) 106, depth sensor(s) 108, and/or communication interface 126. It should be noted that the term “couple” and variations thereof may mean a direct connection (without an intervening component) or an indirection connection (with one or more intervening components). Arrows in the block diagrams described herein may indicate couplings. It should be noted that one or more of the components and/or elements illustrated in FIG. 1 may be optional in some configurations. For example, the electronic device 102 may not include image sensor(s) 104, optical system(s) 106, a display 122, and/or a communication interface 126 in some configurations.

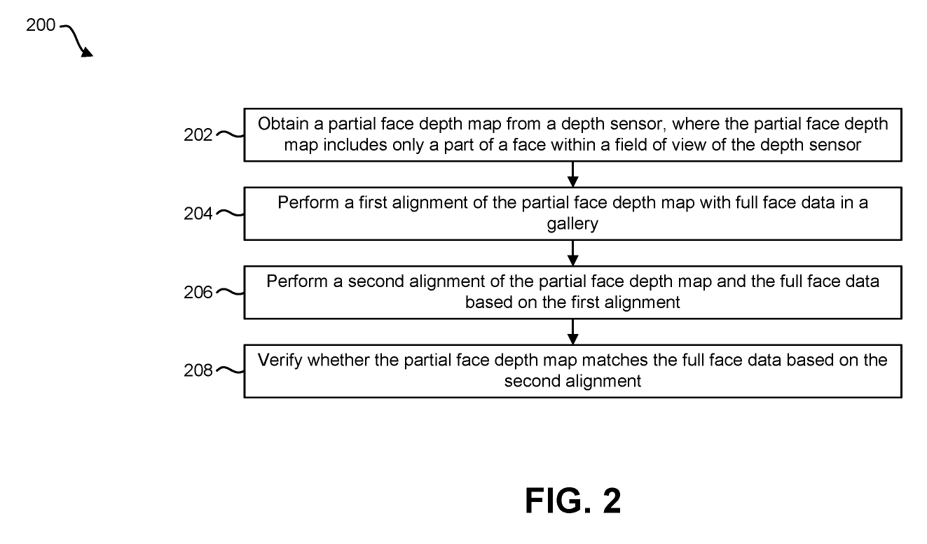

In some configurations, the electronic device 102 may perform one or more of the functions, procedures, methods, steps, etc., described in connection with one or more of FIGS. 2-9. Additionally or alternatively, the electronic device 102 may include one or more of the structures described in connection with one or more of FIGS. 2-9.

The communication interface 126 may enable the electronic device 102 to communicate with one or more other electronic devices. For example, the communication interface 126 may provide an interface for wired and/or wireless communications. In some configurations, the communication interface 126 may be coupled to one or more antennas 128 for transmitting and/or receiving radio frequency (RF) signals. Additionally or alternatively, the communication interface 126 may enable one or more kinds of wireline (e.g., Universal Serial Bus (USB), Ethernet, etc.) communication.

In some configurations, multiple communication interfaces 126 may be implemented and/or utilized. For example, one communication interface 126 may be a cellular (e.g., 3G, Long Term Evolution (LTE), CDMA, etc.) communication interface 126, another communication interface 126 may be an Ethernet interface, another communication interface 126 may be a universal serial bus (USB) interface, and yet another communication interface 126 may be a wireless local area network (WLAN) interface (e.g., Institute of Electrical and Electronics Engineers (IEEE) 802.11 interface). In some configurations, the communication interface 126 may send information (e.g., image information, depth information, depth map information, alignment information, face verification information, partial face depth map(s), full face data, etc.) to and/or receive information (e.g., image information, depth information, depth map information, alignment information, face verification information, partial face depth map(s), full face data, etc.) from another device (e.g., a vehicle, a smart phone, a camera, a display, a remote server, etc.).

In some configurations, the electronic device 102 may obtain one or more images (e.g., digital images, image frames, video, etc.). For example, the electronic device 102 may include the image sensor(s) 104 and the optical system(s) 106 (e.g., lenses) that focus images of scene(s) and/or object(s) that are located within the field of view of the optical system 106 onto the image sensor 104. A camera (e.g., a visual spectrum camera) may include at least one image sensor and at least one optical system. In some configurations, the image sensor(s) 104 may capture the one or more images. The optical system(s) 106 may be coupled to and/or controlled by the processor 112. Additionally or alternatively, the electronic device 102 may request and/or receive the one or more images from another device (e.g., one or more external image sensor(s) coupled to the electronic device 102, a network server, traffic camera(s), drop camera(s), automobile camera(s), web camera(s), etc.). In some configurations, the electronic device 102 may request and/or receive the one or more images via the communication interface 126. For example, the electronic device 102 may or may not include camera(s) (e.g., image sensor(s) 104 and/or optical system(s) 106) and may receive images from one or more remote device(s). One or more of the images (e.g., image frames) may include one or more scene(s) and/or one or more object(s). The image(s) may be in the visible domain. For example, the image(s) may include data that represents one or more aspects of visible light (e.g., color space, color model, color, brightness, luminance, etc.).

In some configurations, the electronic device 102 may include an image data buffer (not shown). The image data buffer may buffer (e.g., store) image data from the image sensor 104. The buffered image data may be provided to the processor 112.

In some configurations, the electronic device 102 may include a camera software application and/or a display 122. When the camera application is running, images of objects that are located within the field of view of the optical system(s) 106 may be captured by the image sensor(s) 104. The images that are being captured by the image sensor(s) 104 may be presented on the display 122. In some configurations, these images may be displayed in rapid succession at a relatively high frame rate so that, at any given moment in time, the scene(s) and/or object(s) that are located within the field of view of the optical system 106 are presented on the display 122. The one or more images obtained by the electronic device 102 may be one or more video frames and/or one or more still images. In some configurations, the display 122 may present additional or alternative information. For example, the display 122 may present verification information corresponding to a probe depth map. Additionally or alternatively, the display 122 may present depth information (e.g., numbers representing one or more estimated distances to one or more objects (e.g., selected objects)).

In some configurations, the electronic device 102 may present a user interface 124 on the display 122. For example, the user interface 124 may enable a user to interact with the electronic device 102. In some configurations, the user interface 124 may enable a user to indicate preferences and/or to interact with the electronic device 102.

In some configurations, the display 122 may be a touchscreen that receives input from physical touch (by a finger, stylus, or other tool, for example). For instance, the touchscreen may be an input interface that receives a touch input indicating user preference(s) and/or one or more modifications of electronic device 102 behavior. Additionally or alternatively, the electronic device 102 may include or be coupled to another input interface. For example, the electronic device 102 may include a camera facing a user and may detect user gestures (e.g., hand gestures, arm gestures, eye tracking, eyelid blink, etc.). In another example, the electronic device 102 may be coupled to a mouse and may detect a mouse click indicating an input. It should be noted that no user-initiated input may be utilized in some configurations. For example, the electronic device 102 may perform face verification automatically in some configurations.

The memory 120 may store instructions and/or data. The processor 112 may access (e.g., read from and/or write to) the memory 120. Examples of instructions and/or data that may be stored by the memory 120 may include measured information, depth information, depth maps, image data, object data (e.g., location, size, shape, etc.), partial face depth map(s) (e.g., data corresponding to one or more partial faces, one or more partial face point clouds, etc.), full face data (e.g., data corresponding to one or more full faces, a gallery of full face data, one or more full face depth maps, one or more full face point clouds, etc.), second aligner 114 instructions, depth information obtainer 116 instructions, first aligner 110 instructions, and/or verifier 118 instructions, etc.

The one or more depth sensors 108 may sense (e.g., detect) the depth of a scene. For example, the depth sensor(s) 108 may sample the depth of the scene (e.g., one or more objects and/or terrain) within a field of view (e.g., detection field). The field of view (e.g., detection field) may include a range (e.g., horizontal range, vertical range and/or angular range relative to the depth sensor(s) 108) within which the depth sensor(s) 108 are capable of detecting depth. Examples of depth sensors 108 include infrared time-of-flight (ToF) camera(s), stereoscopic cameras (e.g., image sensor(s) 104 and/or optical system(s) 106), radar, lidar, interferometer, etc. The depth sensor(s) 108 may provide depth information (and/or other information from which depth information may be obtained) to the processor 112. The depth information and/or other information may indicate distance(s) between the depth sensor(s) 108 and the scene.

In some configurations, the depth sensor(s) 108 may be included in the electronic device 102. In other configurations, the depth sensor(s) 108 may be separate from and coupled to or linked to the electronic device 102. For example, the depth sensor(s) 108 may communicate with the electronic device 102 (via the communication interface 126, for example) to provide depth information (and/or information from which depth information may be obtained) to the processor 112. It should be noted that the image sensor(s) 104 and/or optical system(s) 106 (e.g., cameras) may be the depth sensor(s) 108 in some configurations.

The depth sensor(s) 108 may sense depth at one or more samplings. A sampling may be a time at which depth is sensed. For example, the depth sensor(s) 108 may sample depth information (and/or information from which depth information may be obtained) at a first sampling and at a second sampling. It should be noted that as used herein, ordinal terms such as “first,” “second,” “third,” etc., may or may not imply an order. For example, a “first sampling” may occur before, after, concurrently with (e.g., in overlapping time frames) or at the same time as a “second sampling.”

The depth sensor(s) 108 may capture depth information (and/or information for determining depth information). In some configurations, the depth information may include a set of depth measurements (e.g., distances, depths, depth values, etc.). For example, a depth sensor 108 may sample a scene within a field of view (e.g., detection field) to produce the set of depth measurements. The set of depth measurements may be or may be included in a depth map in some configurations.

The depth sensor(s) 108 may sense (e.g., detect, capture, etc.) a partial face depth map. A partial face depth map may include only a part of a face within the field of view of the depth sensor. A partial face depth map may not include information for an entire face. The depth map sensed by the depth sensor(s) 108 may depend on the position and/or orientation of the depth sensor(s) 108 and/or the position and/or orientation of the object(s) that are within the field of view of the depth sensor(s) 108. A partial face depth map may be sensed when the position and/or orientation of the depth sensor(s) 108 and/or the position and/or orientation of the face are such that only a part of the face is indicated in the depth map. For example, a face may be located relative to the depth sensor(s) 108 such that a part of the face is outside of the field of view (e.g., detectable span) of the depth sensor(s) 108 and/or such that a part of the face is turned away from the depth sensor(s) 108. These scenarios may provide depth information of only a part of the face. A field of view that includes a full face may include a span within which both eyes, the nose, and the mouth are located. A partial face depth map may include depth data corresponding to less than both eyes, the nose, and the mouth of a face (e.g., only one eye and a nose; only both eyes; only nose and mouth; only nose, mouth, and one eye; only one eye, only a nose, only a mouth, etc.).

In some configurations, the partial face depth map may not be the result of an occlusion. An occlusion may be an object between a sensor and the face that blocks at least part of the face (e.g., depth measurement of the face). Accordingly, a partial face depth map may result from a face being located partially outside of the field of view of a depth sensor 108 or from a face being partially turned away from the depth sensor 108, and/or may not result from a full face located within the field of view being partially occluded by a separate object in some configurations. A separate object may be an object besides the face or head of the person, for example.

The processor 112 may include and/or implement a depth information obtainer 116. The depth information obtainer 116 may obtain depth information. Depth information may indicate one or more distances to (e.g., depth measurements of, depths of, depth values of, etc.) one or more physical bodies (e.g., objects, faces, terrain, structures, etc.) from the depth sensor(s) 108. For example, depth information may be one or more numerical indications of distance, in units of distance (e.g., feet, inches, yards, miles, meters, centimeters, kilometers, etc.). In some configurations, the depth information obtainer 116 may obtain depth information (and/or other information from which depth information may be determined) from the depth sensor(s) 108 (and/or image sensor(s) 104). The depth information may be obtained at one or multiple samplings over time (e.g., a first sampling, a second sampling, etc.).

In some configurations, the depth information may be obtained (e.g., determined) based on multiple images (e.g., stereoscopic depth determination), motion information, and/or other depth sensing. In some approaches, one or more cameras (e.g., image sensor(s) 104 and/or optical system(s) 106) may be depth sensors 108 and/or may be utilized as depth sensors 108. In some configurations, for example, the depth information obtainer 116 may receive multiple images (from the image sensor(s) 104 and/or from remote image sensor(s)). The depth information obtainer 116 may triangulate one or more objects in the images (in overlapping areas of the images, for instance) to determine the depth information (e.g., distances, depths, depth values, depth measurements, etc.) between an image sensor and the one or more objects. For example, the 3D position of feature points (referenced in a first camera coordinate system) may be calculated from two (or more) calibrated cameras. Then, the depth information may be estimated through triangulation.

In some configurations, the depth information obtainer 116 may determine the depth information based on moving cameras (e.g., an approach referred to as structure from motion (SfM)). For example, depth may be estimated based on two or more image frames due to camera motion (e.g., the motion of the camera(s) relative to one or more objects in a scene). For instance, by observing the motion of an object over time (in images over time or frames, for instance), the depth information obtainer 116 may determine a distance between the image sensor (e.g., image sensor(s) 104 and/or remote image sensor(s)) and the object. The object points from two views may be aligned and/or matched and the relative camera motion may be estimated. Then, the depth information (e.g., distances) of the object may be estimated (e.g., generated) by triangulation.

In some configurations, the depth information obtainer 116 may obtain depth information by utilizing one or more additional or alternative depth sensing approaches. For example, the depth information obtainer 116 may receive information (e.g., measured information) from the depth sensor(s) 108 (and/or image sensor(s) 104) that may be utilized to determine one or more distances of a scene. Examples of other depth sensors include time-of-flight cameras (e.g., infrared time-of-flight cameras), interferometers, radar, lidar, sonic depth sensors, ultrasonic depth sensors, etc. One or more depth sensors 108 may be included within, may be coupled to, and/or may be in communication with the electronic device 102 in some configurations. The depth information obtainer 116 may estimate (e.g., compute) depth information based on the measured information from one or more depth sensors and/or may receive depth information from the one or more depth sensors. For example, the depth information obtainer 116 may receive time-of-flight information from a time-of-flight camera and may compute depth information based on the time-of-flight information.

Additionally or alternatively, the depth information obtainer 116 may request and/or receive depth information directly from the one or more depth sensors 108 (in configurations where the depth sensor(s) 108 directly provides depth information, for example). For instance, stereoscopic visual spectrum cameras (e.g., image sensors 104 and/or optical systems 106) and/or one or more depth sensors 108 may compute depth information (e.g., distances) based on measured information (e.g., images, time, time-of-flight, phase shift, Doppler shift, etc.). Accordingly, the depth information obtainer 116 may receive depth information directly from one or more visual spectrum cameras, one or more infrared time-of-flight cameras, interferometers, lidar, radar, sonic/ultrasonic depth sensors, etc.

In some configurations, a combination of approaches for obtaining depth information (e.g., multi-modal depth) may be implemented. For example, a combination of SfM, stereoscopic triangulation, and lidar may be implemented. Other combinations may be implemented. Utilizing multi-modal depth estimation may improve the quality of the depth information.

The depth information obtainer 116 may obtain (e.g., determine) one or more depth maps. Depth maps may include depth information and/or may be determined based on the depth information. For example, a depth map may be a set of depth information (e.g., depth measurements, distances, etc.) over a range (e.g., horizontal range, vertical range and/or angular range relative to the depth sensor(s) 108) of a scene. In some configurations, the depth information obtainer 116 may receive depth maps from the depth sensor(s) 108. For example, the depth sensor(s) 108 may directly provide depth information (e.g., distances) over the range of the scene.

Additionally or alternatively, the depth information obtainer 116 may obtain (e.g., determine) depth maps based on the depth information. For example, the depth sensor(s) 108 may provide measured information that may be used to determine depth information and/or depth maps. For instance, the measured information may include time-of-flight time measurements, image data, disparity information between images, received (e.g., reflected) signal power, received (e.g., reflected) signal amplitude, Doppler shift, signal phase shift, etc. The depth information obtainer 116 may determine depth maps based on the measured information. For example, the depth information obtainer 116 may calculate a set of depth information (e.g., distances, depths, depth values, etc.) based on received (e.g., reflected) signal power, received (e.g., reflected) signal amplitude, Doppler shift, signal phase shift, image data (e.g., one or more images), stereoscopic image measurements (e.g., disparity between the same point in image data captured by two or more cameras), structure from motion (SfM), etc. In some configurations, a depth map may include a set of depth information (e.g., numerical distances, depths, etc.) and may not include other kinds of data (e.g., visual domain data, time domain data, frequency domain data, etc.). It should be noted that while depth information and/or a depth map may be determined based on visual domain data in some configurations, the depth information and/or depth map itself may or may not include visual domain data (e.g., image data).

The depth information obtainer 116 may obtain a partial face depth map from one or more depth sensors 108. For example, the depth information and/or depth map provided by the depth sensor(s) 108 may include a partial face depth map. As described above, the partial face depth map may include only a part of a face within a field of view of the depth sensor(s) 108 (and/or the partial face depth map may not include information for an entire face). It should be noted that the depth information obtainer 116 may obtain the partial face depth map from one or more depth sensors 108 included in the electronic device 102 or from one or more remote depth sensors 108 (via the communication interface 126, one or more couplings, one or more links, etc., for example). The depth information obtainer 116 may obtain the partial face depth map directly from the one or more depth sensors 108 in some configurations. In other configurations, the depth information obtainer 116 may process information from the depth sensor(s) 108 to obtain the partial face depth map. For example, the depth information obtainer 116 may determine a disparity between images to determine depths, may determine depths based on time of flight measurements, may triangulate image information to determine depths, etc. A set of depths may be included in the partial face depth map. In some configurations, the partial face depth map may be a point cloud corresponding to a partial face.

In some configurations, the depth information obtainer 116 may operate in accordance with one or more of the approaches, functions, procedures, steps, and/or structures described in connection with one or more of FIGS. 2-9. It should be noted that while depth information may be relative to the location of the depth sensor(s) in some configurations, the depth information may or may not be mapped (e.g., transformed) relative to another point in some configurations. For example, the electronic device 102 may map the depth information to be relative to an arbitrary point (e.g., the center of a vehicle, the center of a device, etc.).

The processor 112 may include and/or implement a first aligner 110. The partial face depth map may be provided to the first aligner 110. The first aligner 110 may perform a first alignment (e.g., a coarse alignment) of the partial face depth map with full face data (e.g., full face data in memory 120, in a gallery stored in the memory 120, etc.). For example, the first aligner 110 may determine a transformation (e.g., rigid transformation) between the partial face depth map and the full face data (e.g., full face depth map, full face point cloud, etc.). In some configurations, the first aligner 110 may align the partial face depth with full face data based on one or more features (e.g., 3D features). Examples of features may correspond to one or more of a nose tip, mouth corners, eye corners, irises, etc. The first aligner 110 may determine a transformation (e.g., one or more translations and/or rotations) that approximately aligns one or more features of the partial face depth map to one or more features of the full face data. The partial face depth map may align one or more features to a subset of features of the full face data in some examples.

Performing the first alignment of the partial face depth map with the full face data may produce an alignment. For example, the first aligner 110 may align (e.g., transform) the partial face depth map in order to align the partial face depth map to the full face data. The alignment may include a transformation. For instance, the alignment may include a translation and/or a rotation (e.g., one or more translations and/or rotations, three-dimensional translations, rotations, etc.) between the partial face depth map and the full face data. In some configurations, the processor 112 (e.g., first aligner 110) may determine the transformation for the alignment by estimating a matrix (e.g., a small matrix, a 3×4 matrix, etc.) based on matched feature points (such as corners of the eyes or mouth, for example) between the partial face depth map and the full face depth map. With the estimated matrix, the processor 112 (e.g., first aligner 110) may obtain the alignment by translating and rotating the partial face depth map relative to the full face depth map. This alignment may be global in nature. For example, every point of the partial depth map may be subject to the same translation and rotation to match the full face depth map.

In some configurations, the first aligner 110 may prioritize one or more regions of the full face data for alignment. For example, the first aligner 110 may prioritize one or more regions based on one or more previous alignment and/or matching locations. For instance, if a previous partial face depth map has been previously aligned to a nose and mouth region of the full face data, the first aligner 110 may start with the nose and mouth region in attempting to align a current partial face depth map to the full face data. In some configurations, prioritizing the one or more regions for alignment may be based on learning, mixture weights, and/or transformations.

The processor 112 may include and/or implement a second aligner 114. The alignment (e.g., the aligned partial face depth map, coarse alignment, etc.) may be provided to the second aligner 114. The second aligner 114 may perform a second alignment of the partial face depth map and the full face data based on the first alignment (e.g., the alignment, the transformation, coarse alignment, the aligned partial face depth map, etc.). For example, the second alignment may include performing point cloud matching between the partial face depth map and the full face data. In some configurations, the second alignment may be performed with an aligned (e.g., coarsely aligned) version of the partial face depth map (or the full face data, for instance). In some configurations, the second aligner 114 may perform a finer alignment in comparison with a coarse alignment performed by the first aligner 110. In some implementations, the second aligner 114 may perform iterative closest point (ICP) matching.

In some approaches, one objective of the second aligner 114 may be to perform a second (e.g., local, fine, etc.) alignment after the first (e.g., global, coarse, etc.) alignment. For example, each subset (e.g., small subset) of neighboring data points of the partial depth map may be aligned to corresponding points in the full depth map in an iterative procedure. For instance, a transformation may be determined (e.g., initially determined) based the initial data points corresponding to an initial alignment (e.g., a first alignment). After the transformation, a new correspondence may be established and a new transformation may be determined. This procedure may iterate until an objective function is minimized. This second (e.g., local, fine, etc.) alignment may ensure improved (e.g., the best) registration between the partial face depth map and the full face depth map.

The processor 112 may include and/or implement a verifier 118 in some configurations. The verifier 118 may verify whether the partial face depth map matches the full face data based on the second alignment. For example, the verifier may compare an alignment metric with a threshold to determine whether the partial face depth map matches the full face data. The alignment metric may indicate a degree of similarity or matching between the partial face depth map and the full face data. The alignment metric may be produced by performing the second alignment and/or may be produced based on the second alignment. For example, the second alignment may indicate how closely the partial face depth map conforms to the full face data. Examples of alignment metrics may include correlation measures, difference measures, probability measures, distance measures, etc.

In some configurations, the verifier 118 may compare a correlation measure to a correlation threshold. If the correlation measure is greater than the correlation threshold, the verifier 118 may indicate that the partial face depth map matches the full face data. Otherwise, the verifier 118 may indicate that the partial face depth map does not match the full face data. In some configurations, the verifier 118 may compare a difference measure to a difference threshold. If the difference measure is less than the difference threshold, the verifier 118 may indicate that the partial face depth map matches the full face data. Otherwise, the verifier 118 may indicate that the partial face depth map does not match the full face data. In some configurations, the verifier 118 may compare a probability measure to a probability threshold. If the probability measure is greater than the probability threshold, the verifier 118 may indicate that the partial face depth map matches the full face data. Otherwise, the verifier 118 may indicate that the partial face depth map does not match the full face data. In some configurations, the verifier 118 may compare a distance measure to a distance threshold. If the distance measure is greater than the distance threshold, the verifier 118 may indicate that the partial face depth map matches the full face data. Otherwise, the verifier 118 may indicate that the partial face depth map does not match the full face data.

The verifier 118 may produce a matching indicator. The matching indicator may indicate whether the partial face depth map matches the full face data or not. In some configurations, the matching indicator (or information based on the matching indicator) may be presented on the display(s) 122.

In some configurations, the first aligner 110, the second aligner 114, and/or the verifier 118 may operate in accordance with one or more of the approaches, functions, procedures, steps, and/or structures described in connection with one or more of FIGS. 2-9.

In some configurations, the matching indicator may be provided to an access controller. For example, the access controller may be included in and/or implemented by the processor 112, may be included in another element of the electronic device 102 (e.g., separate access controller hardware), and/or may be included in a separate device. The access controller may allow or deny access to a user based on a partial face depth map captured from the user's face. In one example, the access controller may allow or deny access to one or more functionalities of the electronic device 102. For instance, the access controller may allow a user to access particular programs and/or data on the electronic device 102 (e.g., may unlock the device and/or may log in a user) if the matching indicator indicates a match between the partial face depth map and the full face data. In another example, the access controller may be included in a vehicle. If the verifier 118 (e.g., matching indicator) indicates a match between the partial face depth map and the full face data, the access controller may allow the user to start the vehicle and/or access other vehicle functions. In yet another example, the access controller may be included in a building security system. If the verifier 118 (e.g., matching indicator) indicates a match between the partial face depth map and the full face data, the access controller may allow the user to enter the building (e.g., may unlock a door). In yet another example, the access controller may be included in a television or games console. If the verifier 118 (e.g., matching indicator) indicates a match between the partial face depth map and the full face data, the access controller may allow the user to access certain content (e.g., games, channels, shows, etc.).

In some configurations, partial face depth map matching verification may be augmented with image (e.g., visual spectrum) matching. For example, the electronic device 102 may obtain a partial face image (from one or more image sensors 104 and/or from a remote device). The electronic device 102 may compare (e.g., align, correlate, match, etc.) the partial face image to an image in memory 120 (e.g., a gallery image).

In some configurations, the depth map matching results may be combined with the image matching results (which may increase accuracy and/or confidence, for instance). For example, the verifier 118 may determine whether the obtained data (e.g., the partial face depth map and/or the partial face image) matches stored data (e.g., full face depth map and/or full face image) in memory 120. For instance, the verifier 118 may compare an alignment metric with an alignment threshold for the depth map matching and/or may compare an image matching metric to an image matching threshold for image matching. In some configurations, the verifier 118 may indicate a match if at least one of the two criteria indicates a match. In other configurations, the verifier 118 may indicate a match only if both of the two criteria indicate a match.

In some configurations, the electronic device 102 may optionally employ one or both of depth map matching and image matching based on one or more criteria. For example, the electronic device 102 may employ one or both of depth map matching and image matching based on a time of day and/or a measure of environmental light. For instance, the electronic device 102 may utilize image matching during a daytime period (when it may be assumed that there is sufficient light to capture a useful image, for example) and/or when sufficient environmental light (e.g., a threshold amount of light determined from a captured image or a light sensor) is detected. The image matching may be performed in addition to or alternatively from depth map matching during times with sufficient light. Additionally or alternatively, the electronic device 102 may not utilize image matching during a nighttime period (when it may be assumed that there is insufficient light to capture a useful image, for example) and/or when insufficient environmental light (e.g., less than threshold amount of light determined from a captured image or a light sensor) is detected. Accordingly, only depth map matching may be utilized during times with insufficient light in some configurations.

It should be noted that the alignment(s) and/or matching described herein may be approximate in some cases and/or may indicate an alignment or match with high probability. The alignment(s) and/or matching may not be absolute or perfect in some cases and/or configurations of the systems and methods disclosed herein.

FIG. 2 is a flow diagram illustrating one configuration of a method 200 for verifying a face. The method 200 may be performed by the electronic device 102 described herein, for example.

The electronic device 102 may obtain 202 a partial face depth map from a depth sensor. The partial face depth map may include only a part of a face within a field of view of the depth sensor (and/or may not include information for an entire face). This may be accomplished as described in connection with FIG. 1. For example, the electronic device 102 may obtain depth information and/or other information (e.g., measured information for obtaining depth information) from one or more depth sensors 108. The partial face depth map may be the depth information or may be determined based on the depth information. For example, the partial face depth map may be the depth information (e.g., all or a subset of the depth information) and/or may be based on the depth information (e.g., the partial face depth map may be calculated from the depth information). For instance, the electronic device 102 may obtain 202 a partial face depth map from one or more depth sensors 108 included in the electronic device 102 and/or may request and/or receive the partial face depth map from a remote depth sensor and/or from another device.

The electronic device 102 may perform 204 a first alignment of the partial face depth map with full face data. This may be accomplished as described in connection with FIG. 1. For example, the electronic device 102 may perform 204 a coarse alignment of the partial face depth map with full face data. The full face data may be stored in memory (e.g., in a gallery). In some configurations, the first alignment may be a rigid transformation that approximately aligns the partial face depth map with the full face data. The first alignment may be based on one or more features (e.g., 3D features).

The electronic device 102 may perform 206 a second alignment of the partial face depth map and the full face data based on the first alignment. This may be accomplished as described in connection with FIG. 1. For example, the electronic device 102 may perform 206 a fine alignment of the partial face depth map with full face data. For instance, the second alignment may be more accurate and/or may be performed on a finer scale than the first alignment. In some configurations, performing 206 the second alignment may include performing ICP matching. The second alignment may be performed after the first alignment in some configurations.

The electronic device 102 may verify 208 whether the partial face depth map matches the full face data based on the second alignment. This may be accomplished as described in connection with FIG. 1. For example, the electronic device 102 may compare an alignment metric with a threshold to determine whether the partial face depth map matches the full face data.

In some configurations, the electronic device 102 may perform an operation based on the verification. For example, the electronic device 102 may present a matching indicator on a display. In another example, the electronic device 102 may control user access (e.g., user access to electronic device 102 functionality, to vehicle functionality, to data, to media content, etc.) based on the verification. In yet another example, the electronic device 102 may send a matching indicator to another device.

It should be noted that one or more of the functions, procedures, methods, etc., described in connection with one or more of FIGS. 1 and 2 may be performed for one or more sets of full face data. For example, the electronic device 102 may determine whether a partial face depth map matches full face data for one or more faces.

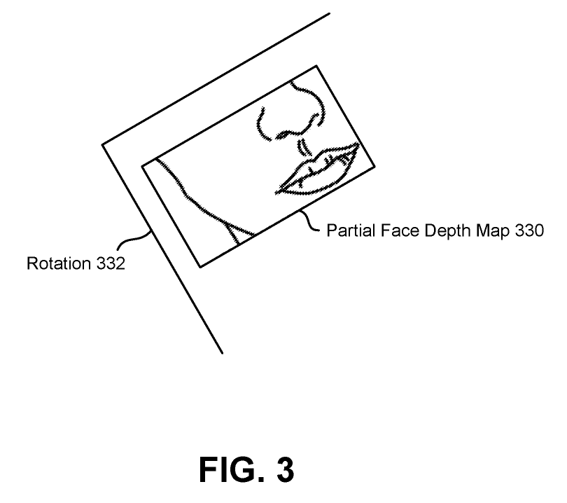

FIG. 3 is a diagram illustrating one example of a visualization of a partial face depth map 330. It should be noted that although the visualization of the partial face depth map 330 is illustrated as an image for convenience, the partial face depth map 330 may include a set of depths (e.g., depth measurements) between a depth sensor and a partial face. In the example illustrated in FIG. 3, the partial face depth map 330 is captured with a rotation 332. Accordingly, a partial face depth map 330 may be rotated and/or translated in a 3D space (relative to a frame of reference, for example). The partial face depth map 330 may not be initially positioned in a designated position (e.g., with the face aligned vertically, horizontally, and/or flatly). For instance, the partial face depth map 330 may not be aligned with a full face data position initially.

As illustrated in FIG. 3, the partial face depth map 330 indicates only part of a face (e.g., only a nose and mouth). For instance, the partial face depth map 330 does not include information for an entire face. In this example, the partial face depth map 330 may only indicate a partial face due to the relative positioning between the user's face and the depth sensor. For instance, the partial face depth map 330 may only indicate a partial face because a portion of the user's face is outside of the field of view of the depth sensor. In particular, only a user's nose and mouth are indicated in the partial face depth map 330, while the user's eyes are outside of the field of view. In this example, the partial face depth map 330 is not occluded. In particular, there are no intervening objects between the depth sensor and the user's face.

One objective of some configurations of the systems and methods disclosed herein may be to perform partial face verification based on a depth sensor. For example, some configurations may seek to verify whether the partial face depth map 330 matches full face data or a known person.

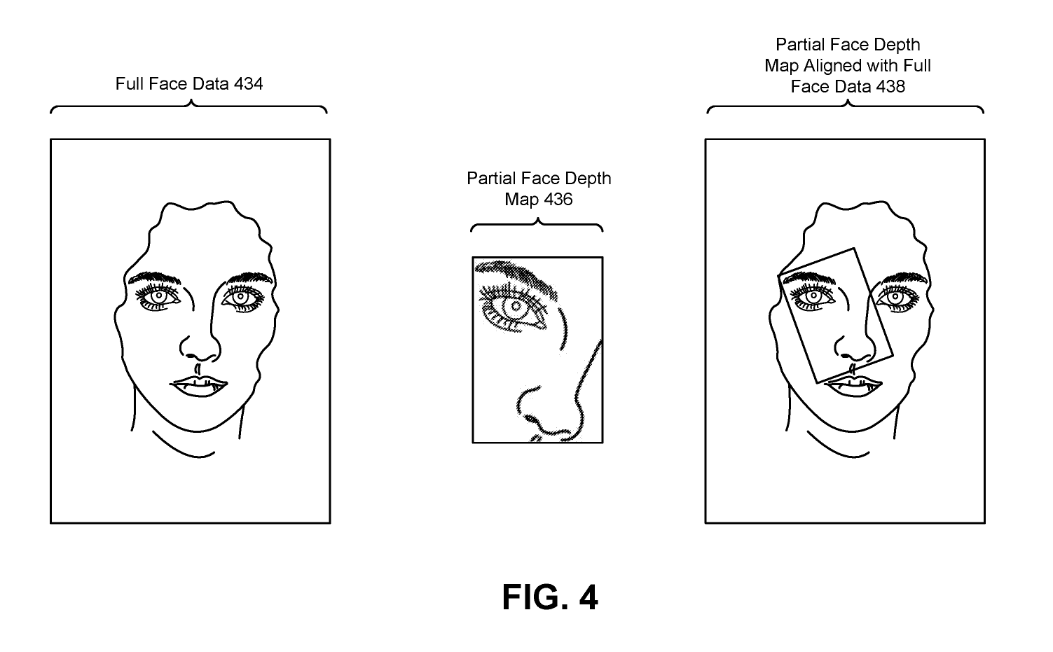

FIG. 4 is a diagram illustrating an example of aligning a partial face depth map 436 with full face data 434. In particular, FIG. 4 illustrates a visualization of full face data 434, a visualization of a partial face depth map 436, and a visualization of the partial face depth map aligned with full face data 438.

The full face data 434 may be obtained previous to alignment (e.g., runtime). For example, the electronic device 102 may obtain full face data 434 during an enrollment stage. In some configurations, the electronic device 102 may capture full face data 434 of a user during the enrollment stage. In some configurations, the electronic device 102 may request and/or receive the full face data 434 of a user from another device during the enrollment stage. For example, during the enrollment stage, the electronic device 102 may obtain full face data 434 of a user (e.g., a known user, an authorized user, an identified user, etc.). In some approaches, the electronic device 102 may obtain (e.g., request and/or receive) one or more additional types of information (e.g., user name, user identifier, authorized function(s) to be performed for the user, user settings, etc.) during the enrollment stage.

The partial face depth map 436 may be obtained at runtime. In some configurations, the electronic device 102 may capture the partial face depth map 436 of a user during runtime. In some configurations, the electronic device 102 may request and/or receive the partial face depth map 436 of a user from another device during runtime.

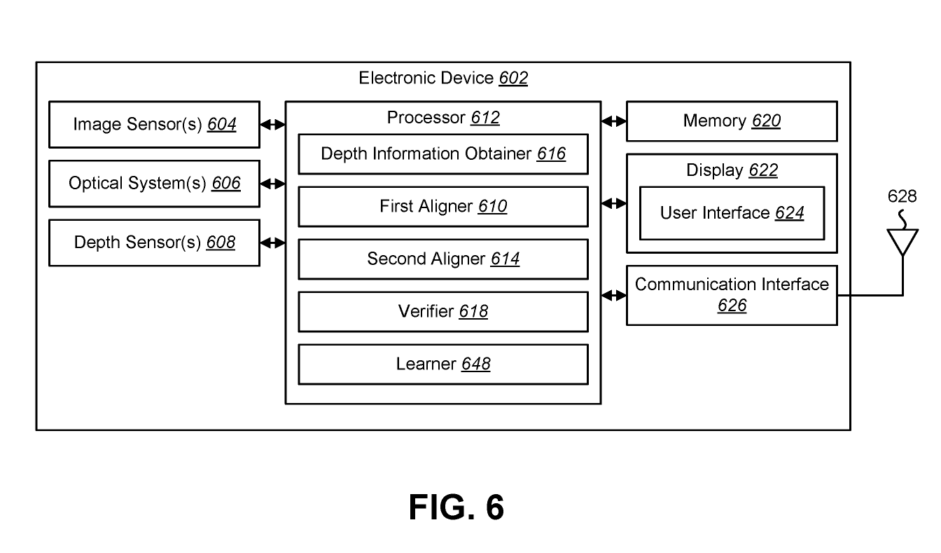

The electronic device 102 may perform a first alignment (e.g., a coarse alignment) and a second alignment (e.g., a fine alignment, fine matching, etc.) to result in the partial face depth map being aligned with the full face data 438. In some configurations, the first alignment (e.g., coarse alignment) may attempt to align the partial face depth map 436 beginning with one or more prioritized regions of the full face data 434. The one or more prioritized regions may be indicated by a set of mixture weights and/or transformations learned via global matching. More detail is given in connection with one or more of FIGS. 6-8.

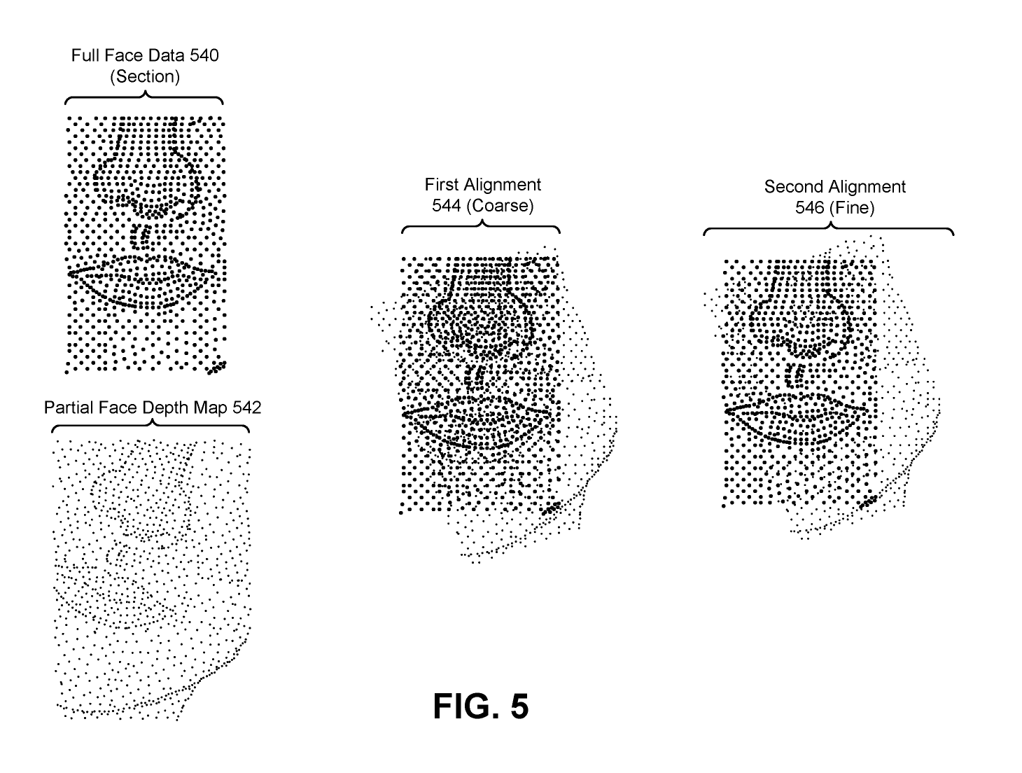

FIG. 5 is a diagram illustrating one example of a first alignment 544 and a second alignment 546. In particular, FIG. 5 illustrates an example of full face data 540 and an example of a partial face depth map 542. For convenience, only a section of the full face data 540 is illustrated.

In some configurations of the systems and methods disclosed herein, an electronic device 102 may perform a first alignment (e.g., a coarse alignment) and a second alignment (e.g., a fine alignment) between a partial face depth map 542 and full face data 540. In the example illustrated in FIG. 5, the first alignment 544 may be a coarse alignment, where a rigid transformation is determined to approximately align the partial face depth map 542 with the full face data 540. The second alignment 546 may be a fine alignment, where ICP matching is performed to further align the partial face depth map 542 with the full face data 540. For example, the first alignment may be a global alignment and the second alignment may be a local alignment as described herein.

FIG. 6 is a block diagram illustrating a more specific example of an electronic device 602 in which systems and methods for verifying a face may be implemented. The electronic device 602 described in connection with FIG. 6 may be an example of the electronic device 102 described in connection with FIG. 1. The electronic device 602 may include one or more components or elements. One or more of the components or elements may be implemented in hardware (e.g., circuitry) or a combination of hardware and software (e.g., a processor with instructions).

In some configurations, the electronic device 602 may include a processor 612, a memory 620, one or more displays 622, one or more image sensors 604, one or more optical systems 606, one or more depth sensors 608, and/or a communication interface 626. The processor 612, memory 620, one or more displays 622, one or more image sensors 604, one or more optical systems 606, one or more depth sensors 608, and/or communication interface 626 described in connection with FIG. 6 may be examples of corresponding components described in connection with FIG. 1 and/or may function similarly to corresponding components described in connection with FIG. 1. The processor 612 may include and/or implement a depth information obtainer 616, a first aligner 610, a second aligner 614, a verifier 618, and/or a learner 648. The depth information obtainer 616, first aligner 610, second aligner 614, and/or verifier 618 may be examples of corresponding components described in connection with FIG. 1 and/or may function similarly to corresponding components described in connection with FIG. 1. The user interface 624 described in connection with FIG. 6 may be an example of the user interface 124 described in connection with FIG. 1 and/or may function similarly to the user interface 124 described in connection with FIG. 1.

In some configurations, the electronic device 602 may perform one or more of the functions, procedures, methods, steps, etc., described in connection with one or more of FIGS. 1-5 and 7-9. Additionally or alternatively, the electronic device 602 may include one or more of the structures described in connection with one or more of FIGS. 1-5 and 7-9.

The processor 612 may include and/or implement a learner 648. The learner 648 may learn one or more locations of the partial face depth map relative to the full face data. The locations may indicate prioritized regions of the full face data where the partial face depth map alignment may be performed. For example, the locations may indicate regions where one or more partial face depth maps (e.g., previous partial face depth maps) have been aligned. Accordingly, the locations may indicate regions near where the partial face depth map may be aligned with an increased likelihood in comparison to other regions. In some approaches, learning may be carried out for one or more verifications (e.g., initial verifications, a particular number of verifications, etc.).

In some configurations, the learner 648 may perform learning to determine a set of mixture weights and/or one or more transformations. The mixture weights and/or transformation(s) may indicate an expected frequency and/or location of a partial face depth map relative to the full face data. In some configurations, the first aligner 610 may prioritize one or more regions for alignment based on the mixture weights and/or transformation(s).

In some configurations, the learner 648 may perform learning as follows. In the learning procedure, a global search may be carried out. The global search may include searching in a range over the entire full face data (e.g., over all samples or a downsampled or decimated set of samples). In some configurations, the global search may be an exhaustive search, where all of the full face data is searched. The global search between the partial face depth map (e.g., probe) and the full face data (e.g., gallery 3D face) may generate a matching metric (e.g., score) and a 3D transformation (e.g., rotation and translation, (R, T), etc.). During or after learning, the accumulated transformation information (e.g., (R, T)) may be clustered as one or more mixture transformations with weights (pᵢ). The mixture weight(s) and/or transformation(s) may describe the expected frequency and/or location of the partial face depth map (e.g., probe) as prior probability for the alignment. In some configurations, the mixture results may be expressed as given in Equation (1).

$$G ( x ) = {\sum }_{i = 1}^{N} {p}_{i} ( x ) E ( x ) \qquad ( 1 )$$

In Equation (1), x may represent a partial face depth map (e.g., one or more 3D keypoints or features of the partial face depth map), pᵢ may represent the mixture weight(s) and/or transformation(s), and E may represent one alignment or matching (e.g., an alignment or matching function) given the partial face depth map and the full face data (e.g., a gallery face). In particular, pᵢ may represent the probability of a match (e.g., expected frequency and/or location) and/or E may provide an alignment or matching metric (e.g., matching score). In some configurations, E may be implemented as a Gaussian distribution regression with variables μᵢ and πᵢ, where μᵢ is the mean and πᵢ is the covariance of the Gaussian distribution. For example, E(x) in Equation (1) may be replaced with E(x;μᵢ,πᵢ). Accordingly, μᵢ and πᵢ may be optional. G(x) is the sum result of the mixture distributions or matching scores from multiple matching components.

Given a partial face depth map (e.g., a new partial face depth map, a subsequent partial face depth map, etc.), the first alignment (e.g., coarse alignment) may use the mixture weights and/or transformations and start from the highest prior mixture weight and/or transformation(s) to expedite the procedure. It should be noted that the learner 648 may perform offline learning and/or online learning. Offline learning may be performed before verification is carried out (e.g., in a training stage before verification). Online learning may be performed during or with verification (e.g., the global search of the full face data may be applied to verify the current partial face depth map, for one or more verifications). Accordingly, offline learning, online learning, or a combination of both may be implemented in some configurations of the systems and methods disclosed herein.

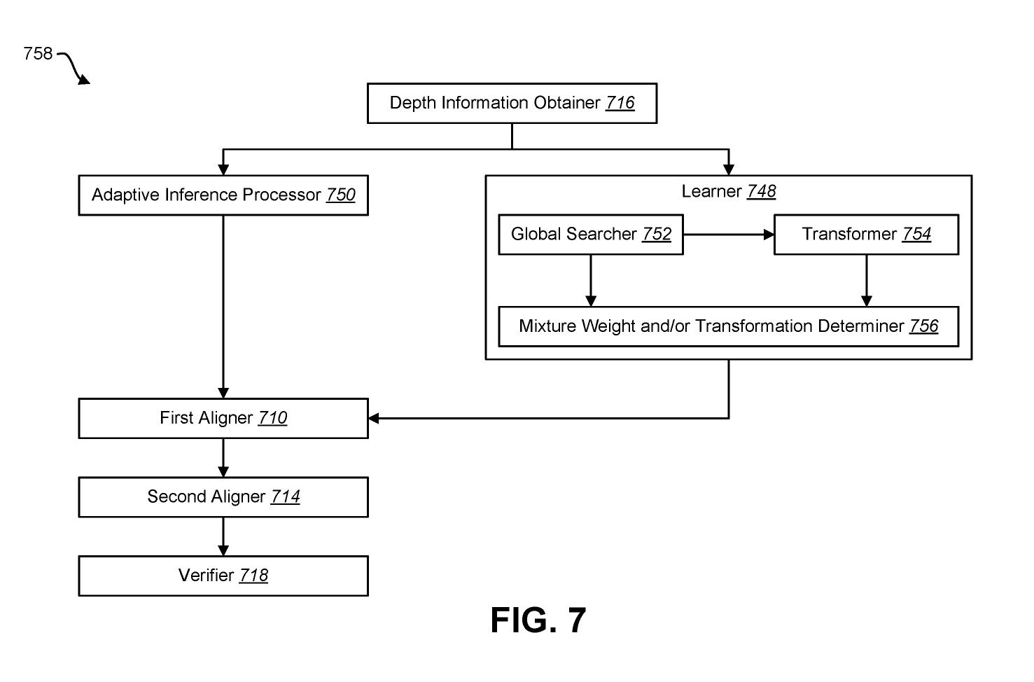

FIG. 7 is a block diagram illustrating an example of several components 758 that may be implemented for verifying a face in some configurations of the systems and methods disclosed herein. For example, one or more of the components 758 may be implemented in a processor (e.g., processor 112, processor 612, etc.) with instructions and/or in hardware. For instance, one or more of the components 758 may be implemented in one or more of the electronic devices (e.g., electronic device 102, electronic device 602, etc.) described herein.

The depth information obtainer 716 may obtain depth information. This may be accomplished as described in connection with one or more of FIGS. 1-2 and 6. For example, the depth information obtainer 716 may obtain a partial face depth map. The partial face depth map may be provided to an adaptive inference processor 750 and to a learner 748. The learner 748 may be an example of the learner 648 described in connection with FIG. 6.

During learning, the learner 748 may perform learning to determine a set of mixture weights and/or transformation(s). The mixture weights and/or transformation(s) may indicate an expected frequency and location of a partial face depth map relative to the full face of data. As illustrated in FIG. 7, the learner 748 may include a global searcher 752, a transformer 754, and a mixture weight and/or transformation (e.g., prior) determiner 756.

The global searcher 752 may perform global searching between the partial face depth map and the full face data. For example, the global searcher 752 may search for a location and/or orientation where the partial face depth map most closely matches the full face data. As described above, the global search may include searching in a range over the entire full face data (e.g., over all samples or a downsampled or decimated set of samples). For example, each subset (e.g., small subset) of neighboring data points of the partial depth map may be aligned to corresponding points in the full depth map in an iterative procedure. For instance, a transformation may be determined (e.g., initially determined) based the initial data points corresponding to an initial alignment (e.g., a first alignment). The global searcher 752 may control the transformer 754 to translate and/or rotate the partial face depth map as part of the global search. After the transformation, a new correspondence may be established and a new transformation may be determined. This procedure may iterate until an objective function is minimized. The global searcher 752 may produce one or more matching metrics (e.g., score(s)). The matching metric(s) may be provided to the mixture weight and/or transformation (e.g., prior) determiner 756.

The transformer 754 may produce one or more translations and/or rotations. The translation(s) and/or rotation(s) may be provided to the mixture weight and/or transformation determiner 756. The mixture weight and/or transformation determiner 756 may determine a set of mixture weights and/or transformation(s) based on the accumulated matching metric(s), the rotation(s), and/or the translation(s). The set of mixture weights and/or transformation(s) may be provided to the first aligner 710.

The adaptive inference processor 750 may determine when to start the inference. For example, if the partial face depth map size is greater than a threshold and/or has enough points (e.g., at least a threshold number of points), the inference may start.

The first aligner 710 may perform a first alignment based on the output of the inference processor and based on the set of mixture weights and/or transformation(s). For example, the first aligner may prioritize one or more regions for alignment based on the mixture weights and/or transformation(s). For instance, the first aligner 710 may attempt to align a partial face depth map with the full face data at and/or within a range of one or more regions indicated by the mixture weights and/or transformation(s). The one or more regions may be areas that have a higher probability than other areas of matching the partial face depth map. For example, the one or more regions may be regions where one or more previous partial face depth maps have aligned with the full face data. In some configurations, the first aligner 710 may determine a rigid transformation that approximately aligns the partial face depth map with the full face data. The first aligner 710 may be an example of one or more corresponding components described in connection with one or more of FIGS. 1 and 6. The first aligner may perform a coarser alignment than that of the second aligner 714.

The second aligner 714 may perform a second alignment based on the first alignment. For example, the second aligner 714 may perform a finer alignment of the partial face depth map based on the first alignment. The second aligner 714 may produce an alignment metric, which may be provided to the verifier 718. The second aligner 714 may be an example of one or more corresponding components described in connection with one or more of FIGS. 1 and 6.

The verifier 718 may verify whether the partial face depth map matches the full face data based on the second alignment. For example, the verifier 718 may determine whether the partial face depth map matches the full face data based on the alignment metric from the second aligner 714. The verifier 718 may be an example of one or more corresponding components described in connection with one or more of FIGS. 1 and 6.

It should be noted that the learning procedures may be carried out for a limited number of partial face depth maps in some configurations. For example, the learner 748 may perform global searching and may determine mixture weights and/or transformation(s) for a number of partial face depth maps. After these learning procedures have been performed, the learner 748 may discontinue performing the global search. Instead, first aligner 710 may perform the first alignment based on the set of mixture weights and/or transformation(s) from previous partial face depth maps and/or the output of the adaptive inference processor 750. This may help to reduce the amount of processing for verifying subsequent partial face depth maps after the learning stage. During and/or after learning, the verifier 718 may compare a measurement score to a threshold. If the measurement score is greater than the threshold, the verifier 718 may indicate that the partial face depth map matches the full face data. Otherwise, the verifier 718 may indicate that the partial face depth map does not match the full face data.

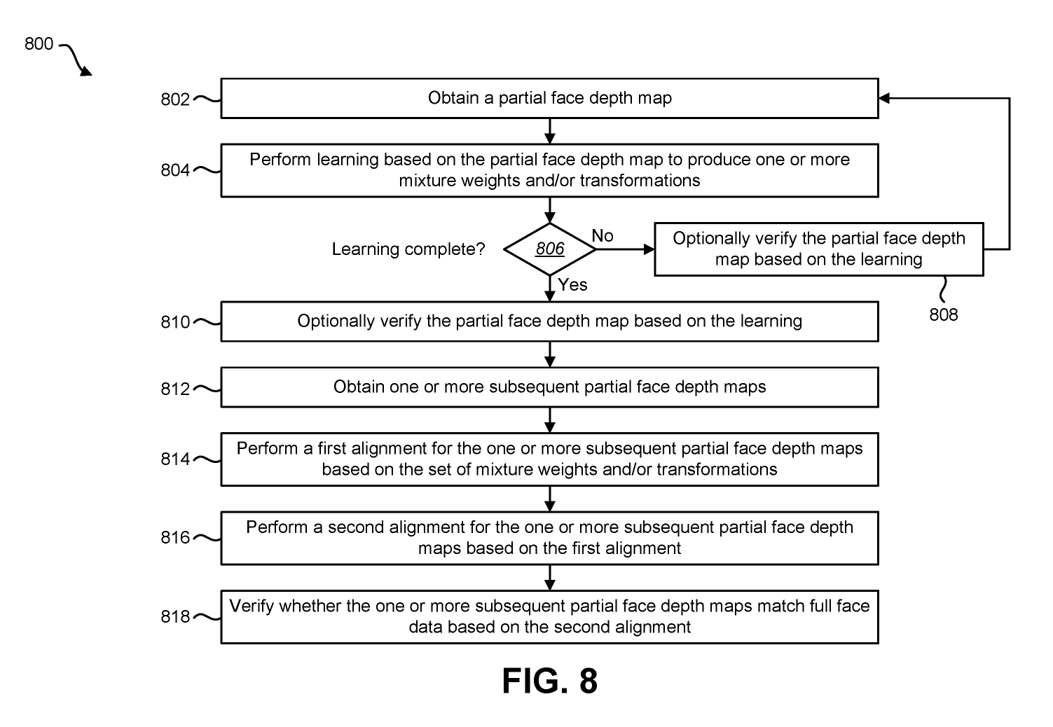

FIG. 8 is a flow diagram illustrating one configuration of a method 800 for learning mixture weights and transformations. The method 800 may be performed by one or more of the electronic devices 102, 602 described herein and/or by one or more of the components 758 described herein.

The electronic device 102 may obtain 802 a partial face depth map. This may be accomplished as described in connection with one or more of FIGS. 1-2 and 6-7.

The electronic device 102 may perform 804 learning based on the partial face depth map to produce one or more mixture weights and/or one or more transformations. This may be accomplished as described in connection with one or more of FIGS. 1 and 6-7.

The electronic device 102 may optionally determine 806 whether learning is complete. For example, the electronic device 102 may determine whether learning has been performed from a threshold number of partial face depth maps and/or whether the set of mixture weights and/or transformation(s) has a threshold amount of data (and/or whether the set of mixture weights and/or transformation(s) has stabilized).

If learning is not complete, the electronic device 102 may optionally verify 808 the partial face depth map based on the learning. For example, the electronic device 102 may determine whether the partial face depth map matches the full face data based on the matching metric produced by a global search. The electronic device 102 may then repeat one or more of the steps of the method 800 (e.g., steps 802 and 804) for one or more additional partial face depth maps until learning is complete.

If learning is complete, the electronic device 102 may optionally verify 810 the partial face depth map based on the learning. For example, the electronic device 102 may determine whether the partial face depth map matches the full face data based on the matching metric produced by a global search. It should be noted that optionally verifying 808, 810 the partial face depth map may depend on whether the learning is being carried out online or offline in some configurations. If online, then the electronic device 102 may verify 808, 810. If offline, then the electronic device 102 may not verify.

The electronic device 102 may obtain one or more subsequent partial face depth maps. This may be accomplished as described in connection with one or more of FIGS. 1-2 and 6-7.

The electronic device 102 may perform 814 a first alignment for the one or more subsequent partial face depth maps based on the set of mixture weights and/or one or more transformations. This may be accomplished as described in connection with one or more of FIGS. 1 and 6-7.

The electronic device 102 may perform 816 a second alignment for the one or more subsequent partial face depth maps based on the first alignment. This may be accomplished as described in connection with one or more of FIGS. 1-2 and 6-7.

The electronic device 102 may verify 818 whether the one or more subsequent partial face depth maps match full face data based on the second alignment. This may be accomplished as described in connection with one or more of FIGS. 1-2 and 6-7.

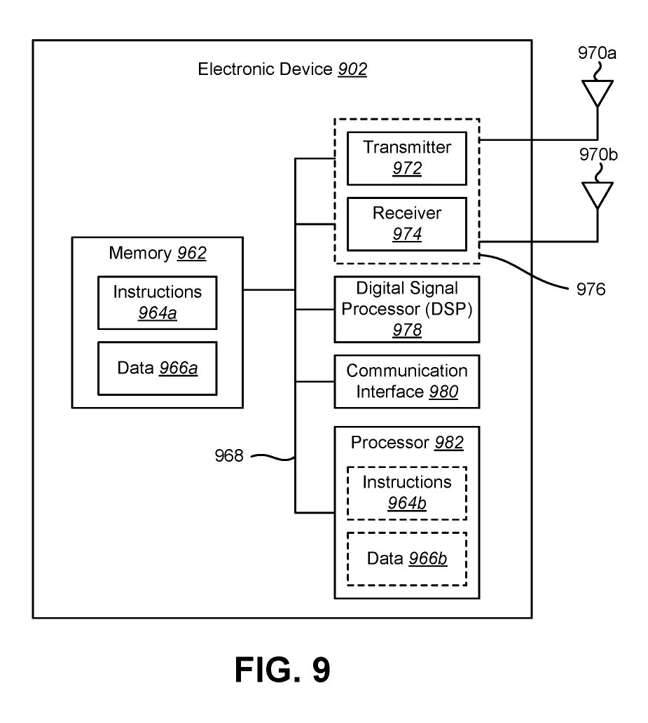

FIG. 9 illustrates certain components that may be included within an electronic device 902 configured to implement various configurations of the systems and methods disclosed herein. Examples of the electronic device 902 may include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, gaming consoles, personal digital assistants (PDAs), set-top boxes, surveying devices, mappers, etc. The electronic device 902 may be implemented in accordance with the electronic devices 102, 602 described in connection with one or more of FIGS. 1 and 6 and/or in accordance with one or more of the component 758 described in connection with FIG. 7. The electronic device 902 includes a processor 982. The processor 982 may be a general purpose single- or multi-chip microprocessor (e.g., an ARM), a special purpose microprocessor (e.g., a digital signal processor (DSP)), a microcontroller, a programmable gate array, etc. The processor 982 may be referred to as a central processing unit (CPU). Although just a single processor 982 is shown in the electronic device 902, in an alternative configuration, a combination of processors (e.g., an ARM and DSP) could be implemented.

The electronic device 902 also includes memory 962. The memory 962 may be any electronic component capable of storing electronic information. The memory 962 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 966a and instructions 964a may be stored in the memory 962. The instructions 964a may be executable by the processor 982 to implement one or more of the methods (e.g., method 200, method 800), procedures, steps, and/or functions described herein. Executing the instructions 964a may involve the use of the data 966a that is stored in the memory 962. When the processor 982 executes the instructions 964, various portions of the instructions 964b may be loaded onto the processor 982 and/or various pieces of data 966b may be loaded onto the processor 982.

The electronic device 902 may also include a transmitter 972 and a receiver 974 to allow transmission and reception of signals to and from the electronic device 902. The transmitter 972 and receiver 974 may be collectively referred to as a transceiver 976. One or more antennas 970a-b may be electrically coupled to the transceiver 976. The electronic device 902 may also include (not shown) multiple transmitters, multiple receivers, multiple transceivers and/or additional antennas.

The electronic device 902 may include a digital signal processor (DSP) 978. The electronic device 902 may also include a communication interface 980. The communication interface 980 may allow and/or enable one or more kinds of input and/or output. For example, the communication interface 980 may include one or more ports and/or communication devices for linking other devices to the electronic device 902. In some configurations, the communication interface 980 may include the transmitter 972, the receiver 974, or both (e.g., the transceiver 976). Additionally or alternatively, the communication interface 980 may include one or more other interfaces (e.g., touchscreen, keypad, keyboard, microphone, camera, etc.). For example, the communication interface 980 may enable a user to interact with the electronic device 902.

The various components of the electronic device 902 may be coupled together by one or more buses, which may include a power bus, a control signal bus, a status signal bus, a data bus, etc. For the sake of clarity, the various buses are illustrated in FIG. 9 as a bus system 968.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise any medium that can be used to carry or store desired program code in the form of instructions or data structures and that can be accessed by a computer. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method for verifying a face by an electronic device, comprising:
obtaining a partial face depth map from a depth sensor, wherein the partial face depth map does not include information for an entire face;
performing a first alignment of the partial face depth map with full face data in a gallery;
performing a second alignment of the partial face depth map and the full face data based on the first alignment; and
verifying whether the partial face depth map matches the full face data based on the second alignment.

2. The method of claim 1, wherein performing the first alignment comprises determining a rigid transformation between the partial face depth map and the full face data.

3. The method of claim 1, wherein performing the second alignment comprises performing point cloud matching between the partial face depth map and the full face data.

4. The method of claim 1, further comprising performing learning to determine a set of mixture weights and transformations, wherein the mixture weights and transformations indicate an expected frequency and location of the partial face depth map relative to the full face data.

5. The method of claim 4, wherein performing the first alignment comprises prioritizing one or more regions for alignment based on the mixture weights and transformations.

6. The method of claim 1, wherein the partial face depth map includes depth information corresponding to less than a nose, a mouth, and both eyes of the face.

7. The method of claim 1, wherein the face is not occluded in a field of view of the depth sensor.

8. An electronic device for verifying a face, comprising:
a depth sensor configured to obtain a partial face depth map, wherein the partial face depth map does not include information for an entire face;
a processor coupled to the depth sensor, wherein the processor is configured to perform a first alignment of the partial face depth map with full face data in a gallery, to perform a second alignment of the partial face depth map and the full face data based on the first alignment, and to verify whether the partial face depth map matches the full face data based on the second alignment.

9. The electronic device of claim 8, wherein the processor is configured to perform the first alignment by determining a rigid transformation between the partial face depth map and the full face data.

10. The electronic device of claim 8, wherein the processor is configured to perform the second alignment by performing point cloud matching between the partial face depth map and the full face data.

11. The electronic device of claim 8, wherein the processor is configured to perform learning to determine a set of mixture weights and transformations, wherein the mixture weights and transformations indicate an expected frequency and location of the partial face depth map relative to the full face data.

12. The electronic device of claim 11, wherein the processor is configured to perform the first alignment by prioritizing one or more regions for alignment based on the mixture weights and transformations.

13. The electronic device of claim 8, wherein the partial face depth map includes depth information corresponding to less than a nose, a mouth, and both eyes of the face.

14. The electronic device of claim 8, wherein the face is not occluded in a field of view of the depth sensor.

15. A computer-program product for verifying a face, comprising a non-transitory tangible computer-readable medium having instructions thereon, the instructions comprising:
code for causing an electronic device to obtain a partial face depth map from a depth sensor, wherein the partial face depth map does not include information for an entire face;
code for causing the electronic device to perform a first alignment of the partial face depth map with full face data in a gallery;
code for causing the electronic device to perform a second alignment of the partial face depth map and the full face data based on the first alignment; and
code for causing the electronic device to verify whether the partial face depth map matches the full face data based on the second alignment.

16. The computer-program product of claim 15, wherein the code for causing the electronic device to perform the first alignment comprises code for causing the electronic device to determine a rigid transformation between the partial face depth map and the full face data.

17. The computer-program product of claim 15, wherein the code for causing the electronic device to perform the second alignment comprises code for causing the electronic device to perform point cloud matching between the partial face depth map and the full face data.

18. The computer-program product of claim 15, further comprising code for causing the electronic device to perform learning to determine a set of mixture weights and transformations, wherein the mixture weights and transformations indicate an expected frequency and location of the partial face depth map relative to the full face data.

19. The computer-program product of claim 18, wherein the code for causing the electronic device to perform the first alignment comprises code for causing the electronic device to prioritize one or more regions for alignment based on the mixture weights and transformations.

20. The computer-program product of claim 15, wherein the partial face depth map includes depth information corresponding to less than a nose, a mouth, and both eyes of the face.
